(19) United States
(12) Patent Application Publication
(10) Pub. No.: US 2019/0103616 A1
(43) Pub. Date: Apr. 4, 2019

(54) GAS FLOW PASSAGE FORMATION PLATE FOR FUEL CELL AND FUEL CELL STACK

(71) Applicant: TOYOTA SHATAI KABUSHIKI KAISHA, Kariya-shi (JP)

(72) Inventors: Hirotaka NAKAYAMA, Kariya-shi (JP); Yoshinori SHINOZAKI, Kariya-shi (JP); Satoshi FUTAMI, Kariya-shi (JP)

(73) Assignee: TOYOTA SHATAI KABUSHIKI KAISHA, Kariya-shi (JP)

(21) Appl. No.: 16/138,780

(22) Filed: Sep. 21, 2018

(30) Foreign Application Priority Data
Oct. 4, 2017 (JP) 2017-194383

(51) Int. Cl. H01M 8/04291; H01M 8/0258

(52) U.S. Cl. CPC H01M 8/04291; H01M 8/0258

(57) ABSTRACT

A gas flow passage formation plate includes projections arranged in a first direction and a second direction orthogonal to the first direction. The gas flow passage formation plate includes a gas flow passage formed by a portion of the gas flow passage formation plate at a side opposing a membrane electrode assembly including regions between adjacent projections, a water flow passage formed by a portion of the gas flow passage formation plate at a side opposing a partition plate including inside of the projections, and openings each formed in a side wall of the projection connecting inside and outside of the projection. In a state in which the openings sandwich the gas flow passage, the openings are arranged so as not to oppose and overlap each other in a direction orthogonal to a direction in which gas flows.

### BACKGROUND ART

The present invention relates to a gas flow passage formation plate for a fuel cell that is located between a membrane electrode assembly and a partition plate and is included in a separator of cells of the fuel cell, and a fuel cell stack formed by stacking a plurality of cells.

A known solid polymer fuel cell includes a fuel cell stack formed by stacking a plurality of cells. A cell is configured by sandwiching a membrane electrode assembly between two separators. Japanese Patent No. 5560470 discloses an example of a separator that includes a flat partition plate and a gas flow passage formation plate, which is located between the partition plate and the membrane electrode assembly.

In the publication, the gas flow passage formation plate includes a plurality of projections that are arranged in a regular manner. The projections project toward the membrane electrode assembly. The portion of the gas flow passage formation plate at the side opposing the membrane electrode assembly (including parts between adjacent projections) functions as a gas flow passage. The gas flow passage circulate the gas (fuel gas and oxidant gas) supplied into the cell. The portion of the gas flow passage formation plate at the side opposing the partition plate (including inside of projections) functions as a water flow passage. The water flow passage discharges water, which is produced in the cell during power generation, from the cell. Each projection of the gas flow passage formation plate includes an opening that connects the inside (water flow passage) and the outside (gas flow passage) of the projection.

In such a fuel cell stack, the water produced in the membrane electrode assembly during power generation flows into the water flow passage through the openings in the gas flow passage formation plate. The flow pressure of the gas flowing in the water flow passage forces the water out of the water flow passage.

In the fuel cell stack, water in the gas flow passage is drawn into the openings by capillary action and discharged to the water flow passage. Accordingly, if water between adjacent projections of the gas flow passage formation plate (gas flow passage) were to reach the openings in the adjacent projections, the water would be drawn toward the two openings and thus be pulled from two sides. Such a situation will easily hinder the discharge of water from the gas flow passage to the water flow passage, and the water will likely to remain in the gas flow passage. This may increase the pressure loss in the gas flow passage and lower the power generation efficiency of the fuel cell stack.

Accordingly, it is an object of the present invention to provide a gas flow passage formation plate for a fuel cell and a fuel cell stack that allows for quick discharge of water from the gas flow passage to the water flow passage.

### SUMMARY OF THE INVENTION

A gas flow passage formation plate for a fuel cell that achieves the above object is located between a membrane electrode assembly and a partition plate and is included in a separator of a cell in a fuel cell. The gas flow passage formation plate includes a plurality of projections, a gas flow passage, a water flow passage, and a plurality of openings. The projections are arranged in a first direction and a second direction that is orthogonal to the first direction. The projections project toward the membrane electrode assembly. The gas flow passage is formed by a portion of the gas flow passage formation plate at a side opposing the membrane electrode assembly including regions between adjacent projections. The water flow passage is formed by a portion of the gas flow passage formation plate at a side opposing the partition plate including the inside of each of the projections. The openings are each formed in a side wall of one of the projections connecting the inside and the outside of the projection. In a state in which the openings sandwich the regions between adjacent projections, the openings are arranged so as not to oppose and overlap each other in a direction orthogonal to a direction in which gas flows in the regions between adjacent projections.

A gas flow passage formation plate for a fuel cell that achieves the above object is located between a membrane electrode assembly and a partition plate and is included in a separator of a cell in a fuel cell. The gas flow passage formation plate includes a plurality of protrusions, a gas flow passage, a water flow passage, and a plurality of openings. The protrusions are located at intervals. The protrusions are projected toward the membrane electrode assembly. The gas flow passage is formed by a portion of the gas flow passage formation plate at a side opposing the membrane electrode assembly including regions between adjacent protrusions. The water flow passage formed by a portion of the gas flow passage formation plate at a side opposing the partition plate including the inside of each of the protrusions. The openings are each formed in a side wall of one of the protrusions connecting the inside and the outside of the protrusion. The openings are located in only one of the opposing walls of adjacent protrusions.

A fuel cell stack that achieves the above object is formed by stacking a plurality of cells. Each of the cells includes a membrane electrode assembly and a pair of separators that sandwich the membrane electrode assembly. At least one of the two separators includes a partition plate and the above gas flow passage formation plate located between the partition plate and the membrane electrode assembly.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view showing one embodiment of a gas flow passage formation plate and a fuel cell stack;

FIG. 2A is a plan view of the gas flow passage formation plate;

FIG. 2B is a view of the gas flow passage formation plate taken in the direction of arrow B;

FIG. 2C is a view of the gas flow passage formation plate taken in the direction of arrow C;

FIG. 2D is a view of the gas flow passage formation plate taken in the direction of arrow D;

FIG. 3A is a perspective view of the gas flow passage formation plate taken from a diagonally upper side;

FIG. 3B is a perspective view of the gas flow passage formation plate taken from a diagonally lower side;

FIG. 4A is a perspective view of the gas flow passage formation plate taken from a diagonally upper side;

FIG. 4B is a perspective view of the gas flow passage formation plate taken from a diagonally lower side;

FIG. 5 is a schematic cross-sectional view showing a cell;

FIG. 6 is a schematic plan view showing the gas flow passage formation plate;

FIG. 7 is a schematic cross-sectional view showing a cell of a comparative example;

FIG. 8 is a schematic plan view showing the gas flow passage formation plate of the comparative example;

FIG. 9 is a schematic plan view showing the gas flow passage formation plate of a modified example;

FIG. 10 is a schematic plan view showing the gas flow passage formation plate of a modified example;

FIG. 11 is a schematic plan view showing the gas flow passage formation plate of a modified example;

FIG. 12 is a schematic plan view showing the gas flow passage formation plate of a modified example;

FIG. 13 is a schematic plan view showing the gas flow passage formation plate of a modified example; and

FIG. 14 is a schematic plan view showing the gas flow passage formation plate of a modified example.

### EMBODIMENTS OF THE INVENTION

A gas flow passage formation plate and a fuel cell stack in accordance with one embodiment will now be described.

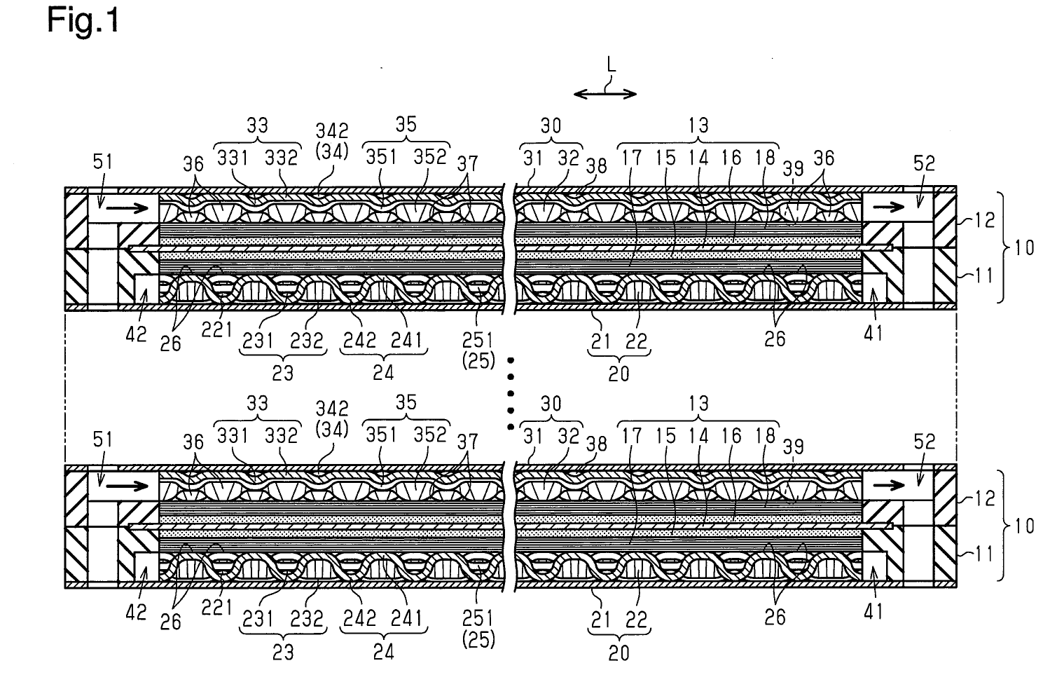

As shown in FIG. 1, the fuel cell stack in the present embodiment is formed by stacking a plurality of cells 10. The fuel cell stack is incorporated in a solid polymer fuel cell. The cell 10 includes a square first frame 11 and a square second frame 12. The frames 11 and 12 sandwich an outer edge of a known membrane electrode assembly 13 that has the form of a square sheet. The membrane electrode assembly 13 has multiple layers including a solid polymer electrolyte membrane 14, a pair of electrode catalyst layers 15 and 16, and a pair of gas diffusion layers 17 and 18. The solid polymer electrolyte membrane 14 is held between the two electrode catalyst layers 15 and 16. The two gas diffusion layers 17 and 18 respectively cover outer surfaces of the electrode catalyst layers 15 and 16.

The membrane electrode assembly 13 is held between a first separator 20 and a second separator 30. The first separator 20 contacts the gas diffusion layer 17 at a cathode side (lower side as viewed in FIG. 1) of the membrane electrode assembly 13. The first separator 20 includes a flat separator 21 that has the form of a flat plate and a gas flow passage formation plate 22. The gas flow passage formation plate 22 is located between the flat separator 21 and the membrane electrode assembly 13. The second separator 30 contacts the gas diffusion layer 18 at an anode side (upper side as viewed in FIG. 1) of the membrane electrode assembly 13. The second separator 30 includes a flat separator 31 that has the form of a flat plate and a gas flow passage formation plate 32. The gas flow passage formation plate 32 is located between the flat separator 31 and the membrane electrode assembly 13. The flat separators 21 and 31 and the gas flow passage formation plates 22 and 32 are formed from a metal plate. In the present embodiment, the flat separators 21 and 31 correspond to partition plates.

Inside the cell 10, a supply passage 41 and a discharge passage 42 are defined by the first frame 11 and the flat separator 21. The supply passage 41 supplies oxidant gas to a gas flow passage 27 from an oxidant gas supply source (not shown). The discharge passage 42 discharges the oxidant gas that has not been used for power generation out of the gas flow passage 27.

Further, inside the cell 10, a supply passage 51 and a discharge passage 52 are defined by the second frame 12 and the flat separator 31. The supply passage 51 supplies fuel gas to a gas flow passage 37 from a fuel gas supply source (not shown). The discharge passage 52 discharges the fuel gas that has not been used for power generation out of the gas flow passage 37.

In FIG. 1, the gas flow passage formation plate 32 of the second separator 30 has a form obtained by vertically and horizontally reversing the gas flow passage formation plate 22 of the first separator 20. Thus, while the gas flow passage formation plate 22 of the first separator 20 will be described in detail, reference numerals “3*” obtained by adding “10” to the reference numerals “2*” of the components of the gas flow passage formation plate 22 of the first separator 20 and reference numerals “3**” obtained by adding “100” to the reference numerals “2**” of the components of the gas flow passage formation plate 22 of the first separator 20 are assigned to the corresponding components of the gas flow passage formation plate 32 of the second separator 30, and redundant explanations are omitted.

The structure of the gas flow passage formation plate 22 will now be described.

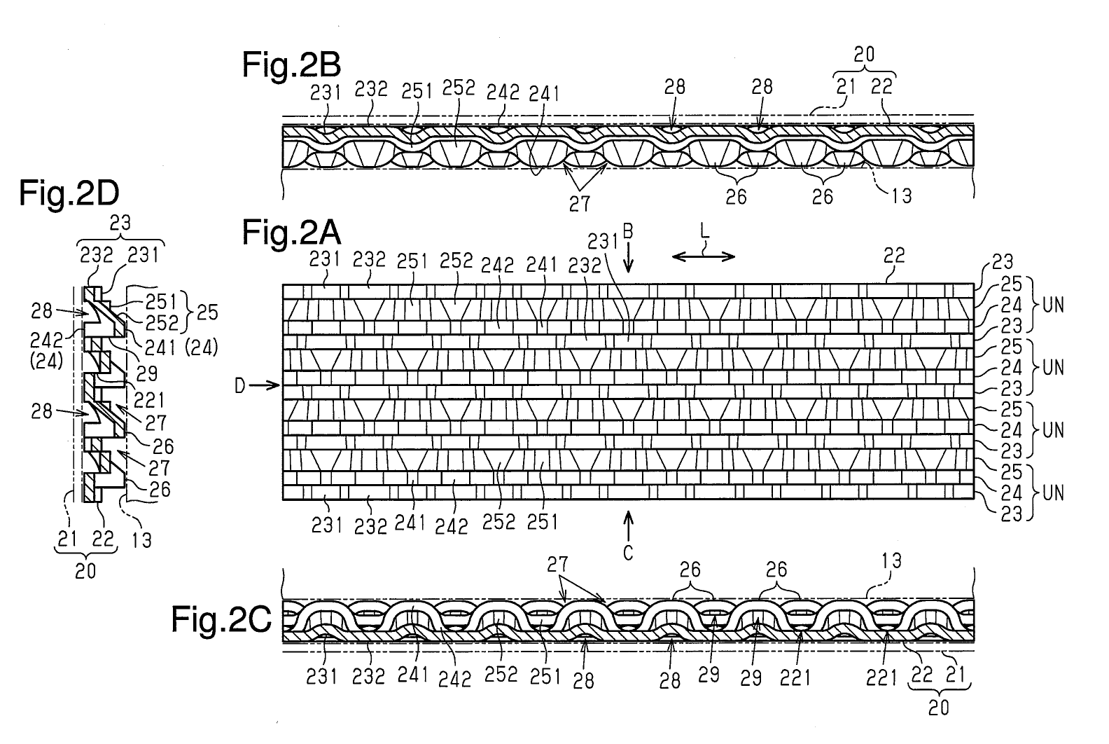

As shown in FIGS. 2A, 2B, 2C, and 2D, the gas flow passage formation plate 22 is formed by roll forming a metal plate such as a stainless steel plate.

The gas flow passage formation plate 22 is formed by arranging three substantially wave-shaped plate portions of different forms (small wave portion 23, large wave portion 24, and middle wave portion 25) in a cyclic manner. The structure in which the small wave portion 23, the large wave portion 24, and the middle wave portion 25 are arranged in this order will be referred to as a unit structure UN. The gas flow passage formation plate 22 includes a plurality of the unit structures UN. Among the three substantially wave-shaped plate portions, the small wave portion 23 has a waveform with the smallest amplitude. The large wave portion 24 has a waveform with the largest amplitude, and the middle wave portion 25 has a waveform with a middle amplitude.

The small wave portion 23 includes parts (projected parts 231) that project toward the membrane electrode assembly 13 and parts (recessed parts 232) that are recessed relative to the membrane electrode assembly 13. Each projected part 231 extends at a location spaced apart from the flat separator 21. Each recessed part 232 includes a surface that opposes and contacts the flat separator 21.

The large wave portion 24 includes parts (projected parts 241) that project toward the membrane electrode assembly 13 and parts (recessed parts 242) that are recessed relative to the membrane electrode assembly 13. Each projected part 241 includes an end surface that contacts the membrane electrode assembly 13. Each recessed part 242 includes a surface that opposes and contacts the flat separator 21.

The middle wave portion 25 is inclined farther away from the membrane electrode assembly 13 as the middle wave portion 25 becomes farther from the large wave portion 24.

In an extension direction L, in which the waveform of the middle wave portion 25 extends, the middle wave portion 25 is formed by gradually inclined parts 251 and steeply inclined parts 252 that are alternately arranged. Each gradually inclined part 251 has a small inclination. Each steeply inclined part 252 has a large inclination. The location of each steeply inclined part 252 of the middle wave portion 25 in the extension direction L coincides with the location of each projected part 241 of the large wave portion 24. Further, the location of each gradually inclined part 251 of the middle wave portion 25 in the extension direction L coincides with the location of each recessed part 242 of the large wave portion 24.

The middle wave portion 25 includes an end opposing the large wave portion 24. Along the end, each steeply inclined part 252 forms a projection that projects toward the membrane electrode assembly 13, and each gradually inclined part 251 forms a recess that is recessed relative to the membrane electrode assembly 13. Along the end of the middle wave portion 25 opposing the large wave portion 24, each projection includes an end that opposes and contacts the membrane electrode assembly 13. Further, along the end of the middle wave portion 25 opposing the large wave portion 24, each recess includes an end that opposes the flat separator 21 and extends between the flat separator 21 and the membrane electrode assembly 13.

The middle wave portion 25 includes an end spaced apart from the large wave portion 24. Along the end, each steeply inclined part 252 forms a recess that is recessed relative to the membrane electrode assembly 13, and each gradually inclined part 251 forms a projection that projects toward the membrane electrode assembly 13. Along the end of the middle wave portion 25 spaced apart from the large wave portion 24, the projections (gradually inclined parts 251) and the recesses (steeply inclined parts 252) both extend between the flat separator 21 and the membrane electrode assembly 13 (specifically, at locations spaced apart from flat separator 21).

The small wave portion 23 is located next to the end of the middle wave portion 25 spaced apart from the large wave portion 24. The end of the middle wave portion 25 spaced apart from the large wave portion 24 (that is, end opposing small wave portion 23) extends at a location that is closer to the membrane electrode assembly 13 than the small wave portion 23. Along the end of the middle wave portion 25 spaced apart from the large wave portion 24, the location of each projection of the middle wave portion 25 in the extension direction L coincides with the location of each projected part 231 of the small wave portion 23. Further, the location of each recess of the middle wave portion 25 in the extension direction L coincides with the location of each recessed part 232 of the small wave portion 23.

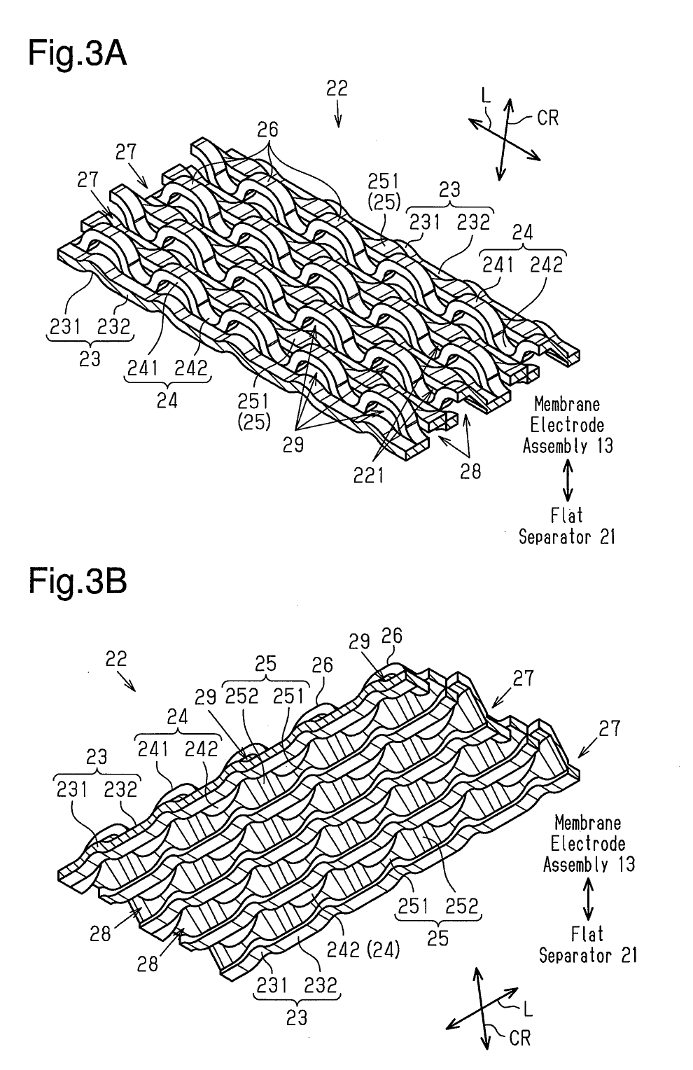

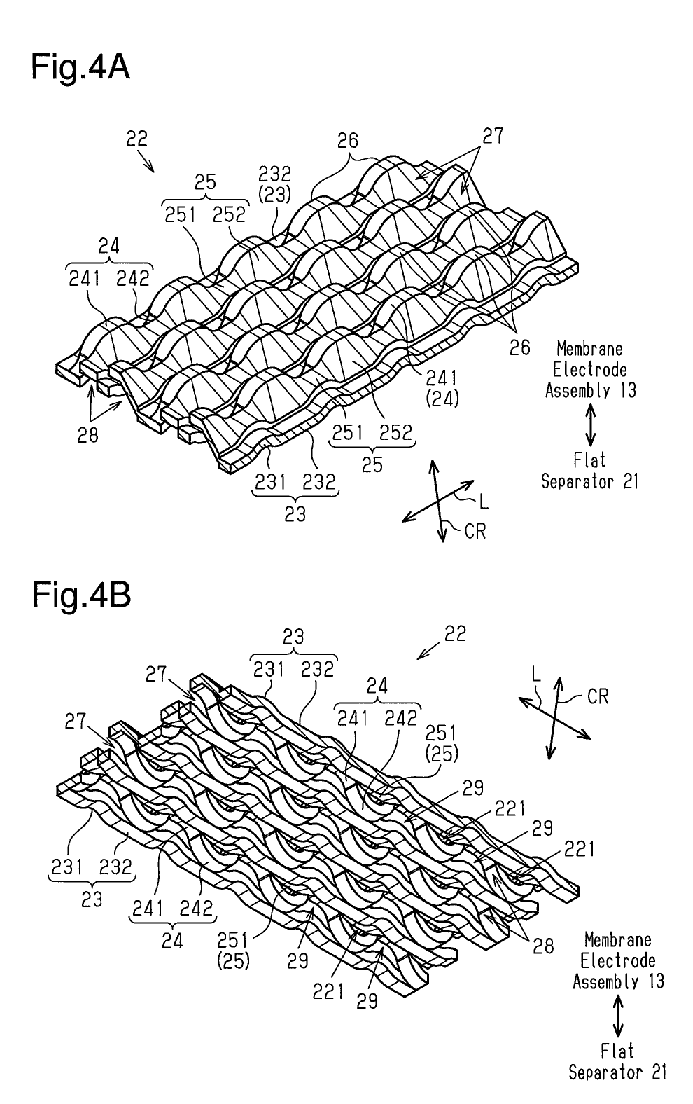

As shown in FIGS. 3A, 3B, 4A, and 4B, the gas flow passage formation plate 22 includes dome-shaped projections 26 that project toward the membrane electrode assembly 13. Each projection 26 is formed by the projected part 241 of the large wave portion 24 and the steeply inclined part 252 of the middle wave portion 25.

On the gas flow passage formation plate 22, two adjacent unit structures UN (refer to FIG. 2) are arranged so that the projections 26 are alternately located in the extension direction L. More specifically, in a direction that is orthogonal to the extension direction L, two adjacent unit structures UN are arranged so that each projection 26 of one unit structure UN is aligned with a part located between two adjacent projections 26 of the other unit structure UN. In this manner, the projections 26 are arranged at equal intervals both in the extension direction L, which is a first direction, and in a second direction that orthogonally intersects the first direction (direction of double-headed arrow CR in FIGS. 3 and 4).

The side of the gas flow passage formation plate 22 opposing the membrane electrode assembly 13 includes the groove-like gas flow passage 27 formed between adjacent projections 26. More specifically, the gas flow passage 27 is defined by side walls of adjacent projections 26 (projected parts 241 of large wave portion 24 and steeply inclined parts 252 of middle wave portion 25) and parts that connect adjacent projections 26 (recessed parts 242 of the large wave portion 24, gradually inclined parts 251 of middle wave portion 25, and small wave portion 23). The gas flow passage 27 extends in a substantially grid-shaped pattern at the side of the gas flow passage formation plate 22 opposing the membrane electrode assembly 13. The gas flow passage 27 mainly functions as a passage that circulates oxidant gas.

As shown in FIG. 4A, at a location at which the projected part 231 of the small wave portion 23 or the steeply inclined part 252 of the middle wave portion 25 is arranged in the gas flow passage 27, part of an interior wall of the gas flow passage 27 is inclined so as to approach the membrane electrode assembly 13 as the recessed part 232 of the small wave portion 23 becomes farther away. Accordingly, some of the oxidant gas flowing in the gas flow passage 27 flows along such inclined parts of the interior wall in the gas flow passage 27 toward the membrane electrode assembly 13 and flows into the gas diffusion layer (refer to FIG. 1).

A location at which the projected part 231 of the small wave portion 23 or the gradually inclined part 251 of the middle wave portion 25 is arranged in the gas flow passage 27 is projected farther toward the membrane electrode assembly 13 than a location at which the recessed part 232 of the small wave portion 23 is arranged in the gas flow passage 27. Accordingly, the projected part 231 of the small wave portion 23 or the gradually inclined part 251 of the middle wave portion 25 locally narrows the cross-sectional area of the gas flow passage 27. Thus, the interior pressure of the gas flow passage 27 is higher at such a part than at other parts of the gas flow passage 27 (more specifically, a location at which recessed part 232 of small wave portion 23 is arranged).

In this manner, in the gas flow passage 27, a pressure difference is generated between opposite sides of each projection 26, that is, between a side of the large wave portion 24 of the projection 26 at which the projected part 231 of the small wave portion 23 is arranged and a side of the steeply inclined part 252 of the projection 26 at which the recessed part 232 of the small wave portion 23 is arranged. The pressure difference directs some of the oxidant gas flowing in the gas flow passage 27 to flow from the side of the projection 26 at which the large wave portion 24 is arranged toward the side at which the steeply inclined part 252 is arranged so as to flow over the projection 26. In this way, some of the oxidant gas flows in the direction that is orthogonal to the extension direction L. In addition, a pressure difference is generated in the gas flow passage 27 in the direction orthogonal to the extension direction L between opposite sides of a part sandwiched by projections 26 that are adjacent to each other in the extension direction L. That is, a pressure difference is generated in the gas flow passage 27 between the location at which the projected part 231 of the small wave portion 23 is arranged and the location at which the recessed part 232 of the small wave portion 23 is arranged. The pressure difference directs some of the oxidant gas flowing in the gas flow passage 27 to flow through the region between adjacent projections 26 arranged in the extension direction L. Accordingly, some of the oxidant gas flows in the direction orthogonal to the extension direction L.

In the present embodiment, the oxidant gas is diffused in the gas flow passage 27 in this way. Some of the oxidant gas flowing in the gas flow passage 27 in the direction orthogonal to the extension direction L flows along the side wall of each projection 26 toward the membrane electrode assembly 13 and into the gas diffusion layer 17.

In this manner, the use of the gas flow passage formation plate 22 allows the oxidant gas to be easily supplied to the membrane electrode assembly 13. This improves the power generation efficiency of the fuel cell.

As shown in FIGS. 2B, 2C, 3B, and 4B, the side of the gas flow passage formation plate 22 opposing the flat separator 21 includes the groove-like water flow passage 28 formed between two adjacent small wave portions 23. More specifically, the water flow passage 28 is defined (including inside of projections 26) by side walls of adjacent small wave portions 23 and the parts that connect the adjacent small wave portions 23 (large wave portions 24 and middle wave portions 25). The water flow passage 28 mainly functions as a passage that discharges the water produced in the membrane electrode assembly 13 during power generation.

As shown in FIGS. 3A and 3B, at the boundary between the small wave portion 23 and the large wave portion 24, a space is formed between each projected part 231 of the small wave portion 23 and the corresponding projected part 241 of the large wave portion 24. The space functions as a through hole (opening 29) that connects the inside of the projection 26 (water flow passage 28) and the outside of the projection 26 (gas flow passage 27). The opening 29 forms a single through hole, and is arranged in the side wall of each projection 26. The projections 26 all include a single opening 29. The openings 29 all open in the same direction (diagonally lower left side as viewed in FIG. 3A).

At the boundary of the large wave portion 24 and the middle wave portion 25 of the gas flow passage formation plate 22, a space is formed between each recessed part 242 of the large wave portion 24 and the corresponding gradually inclined part 251 of the middle wave portion 25. The space functions as a through hole (opening 221) that connects the side of the gas flow passage formation plate 22 opposing the flat separator 21 (water flow passage 28) and the side of the gas flow passage formation plate 22 opposing the membrane electrode assembly 13 (gas flow passage 27).

The openings 29 and 221 function as passages that discharge the water produced in the cell 10 to the water flow passage 28.

As shown in the lower cell 10 of FIG. 1, when fuel gas is supplied into the gas flow passage 37 through the supply passage 51, the fuel gas flows through the gas flow passage 37 into the gas diffusion layer 18. The fuel gas diffuses through the gas diffusion layer 18 and is supplied to the electrode catalyst layer 16. Further, when oxidant gas is supplied into the gas flow passage 27 through the supply passage 41, the oxidant gas flows through the gas flow passage 27 into the gas diffusion layer 17. The oxidant gas diffuses through the gas diffusion layer 17 and is supplied to the electrode catalyst layer 15. In this manner, fuel gas and oxidant gas are supplied to the membrane electrode assembly 13 to generate power in the membrane electrode assembly 13 by electrochemical reaction. During the power generation in the membrane electrode assembly 13, water is produced in the gas diffusion layer 17 (more specifically, on and near interface to electrode catalyst layer 15) at the cathode side.

As shown in FIGS. 2C, 3A, and 3B, the water flows into the gas flow passage 27 of the gas flow passage formation plate 22 and is drawn by capillary action into the water flow passage 28 through the openings 29 and 221. When the water drawn into the water flow passage 28 forms droplets and collects near the openings 29 and 221, the collected water functions as a priming water. In this way, the water flowing in the openings 29 and 221 is drawn by capillary action into the water flow passage 28.

The water drawn into the water flow passage 28 is forced toward a downstream side (left side as viewed in FIG. 1) by the flow pressure of the oxidant gas flowing in the water flow passage 28 and discharged out of the cell 10 through the discharge passage 42 (refer to FIG. 1).

The operation of the gas flow passage formation plate 22 applied in the cell 10 will now be described.

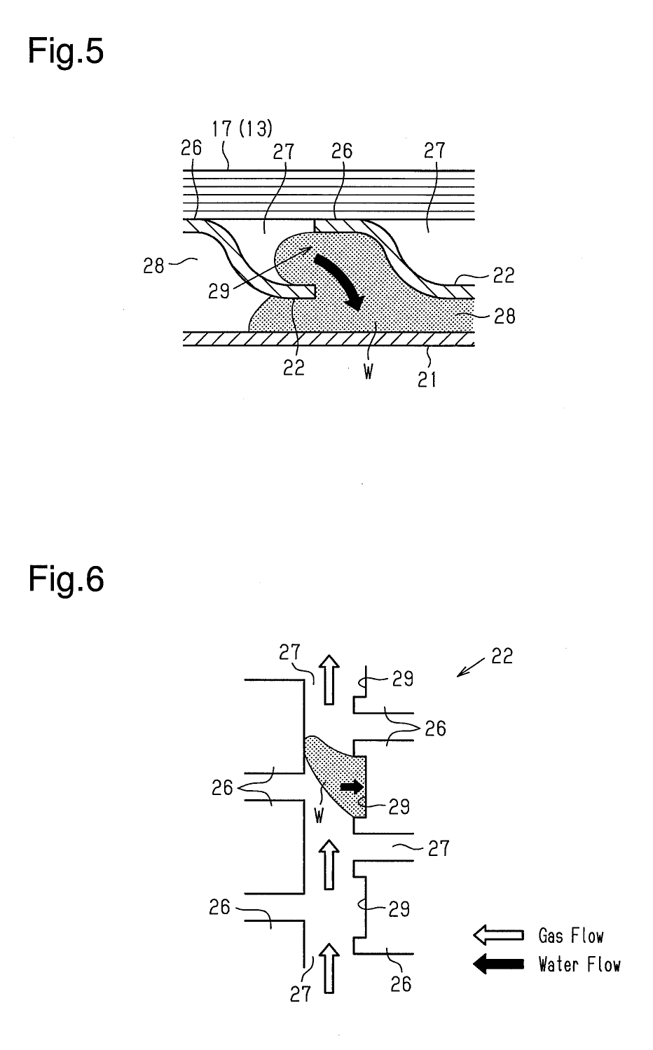

As shown in FIGS. 5 and 6, each projection 26 includes only one opening 29. The openings 29 all open in the same direction (left side as viewed in FIGS. 5 and 6). Thus, the openings 29 in the gas flow passage formation plate 22 are each formed in only one of the opposing walls of adjacent projections 26. Accordingly, water W produced during power generation in the membrane electrode assembly 13 (refer to FIG. 5) flows into the gas flow passage 27 on the gas flow passage formation plate 22 and reaches only one opening 29. Then, water W in the gas flow passage 27 is drawn by capillary action at the openings 29 into the openings 29. In the cell 10 of the present embodiment, water in the gas flow passage 27 is drawn into (discharged to) the water flow passage 28 through a single opening 29.

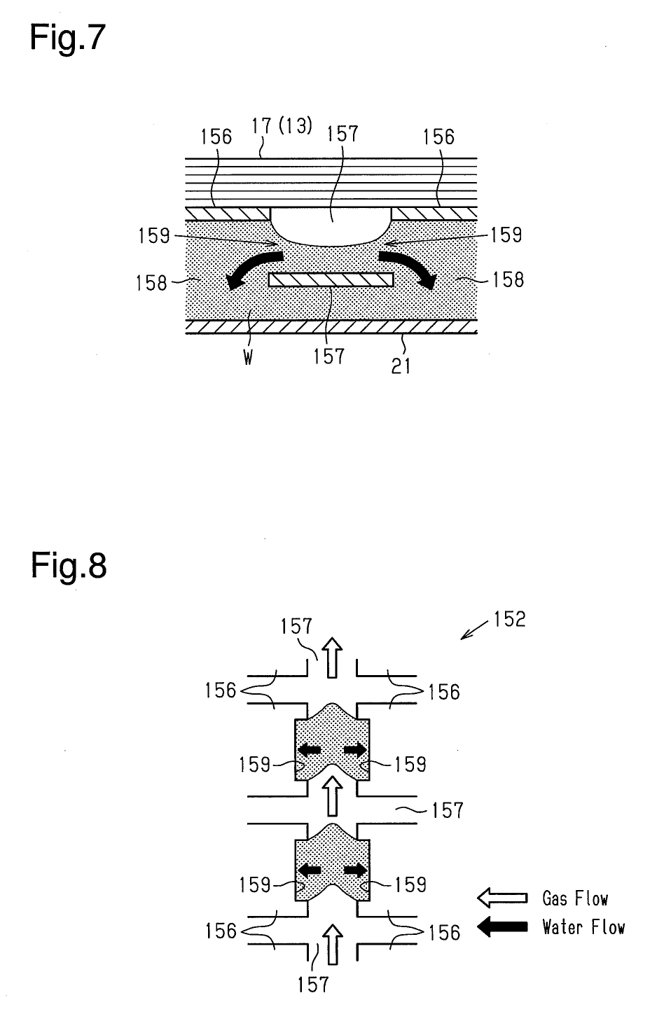

FIGS. 7 and 8 are schematic views showing a cell of a comparative example. As shown in FIGS. 7 and 8, in the cell of the comparative example, openings 159 are formed in opposing walls of two adjacent projections 156 that are arranged in the orthogonal direction (sideward direction as viewed in FIGS. 7 and 8). The openings 159 are aligned in the orthogonal direction. Accordingly, water W produced during power generation in the membrane electrode assembly 13 (refer to FIG. 7) flows into a gas flow passage 157 of a gas flow passage formation plate 152 and reaches the openings 159 in the two side walls of the gas flow passage 27. Thus, as shown by the bolded arrows in FIGS. 7 and 8, water W in the gas flow passage 157 is drawn by capillary action at the openings 159 into the openings 159 while being pulled from two opposite sides. This situation hinders the discharge of water from the gas flow passage 157 to the water flow passage 158, and water W is likely to remain in the gas flow passage 157. In this manner, the water W remaining in the gas flow passage 157 interferes with the oxidant gas flow (shown by non-bolded arrows in FIG. 8) and increases the pressure loss of the gas flow passage 157. This may lower power generation efficiency of the fuel cell stack.

In this regard, in the present embodiment, as shown in FIG. 6, water W flows into the gas flow passage 27 and reaches only one opening 29. This prevents a situation in which water W in the gas flow passage 27 is pulled by the openings toward the opposite sides. Thus, compared to the cell of the comparative example (refer to FIG. 8) that causes the above situation, water W in the gas flow passage 27 is more easily drawn into the water flow passage 28. This allows for quick discharge of water from the gas flow passage 27 to the water flow passage 28.

In the present embodiment, as shown by the bolded arrow in FIG. 6, water W that flows into the gas flow passage 27 is drawn into the openings 29 formed in only one of the side walls (right side as viewed in FIG. 6) of the gas flow passage 27. Accordingly, the cell 10 of the present embodiment would not allow the occurrence of a situation in which water W that flows into the gas flow passage 27 reaches the openings in the side walls of the gas flow passage 27 and is pulled from two sides. Thus, compared to the cell of the comparative example (refer to FIG. 8) that causes the above situation, the water W is more easily pushed by the oxidant gas flow (as shown by non-bolded arrows in FIG. 6) and thus less likely to remain in the gas flow passage 27. Water W that has been pushed toward downstream side with respect to the oxidant gas flow is drawn into the opening 29 located at the downstream side and drawn into (discharged to) the water flow passage 28. This limits increases in the pressure loss of the gas flow passage 27 caused by the remaining water W and ensures power generation efficiency of the fuel cell stack.

In the present embodiment, as shown in FIGS. 3A and 3B, each of the projections 26 includes the opening 29. This allows the openings 29, which function as passages discharging water from the gas flow passage 27 to the water flow passage 28, to be thoroughly arranged over the entire gas flow passage formation plate 22. Accordingly, the side of the gas flow passage formation plate 22 opposing the flat separator 21 (water flow passage 28) functions as a water flow passage having a wide range for water to flow over. This improves the water discharge performance of the cell 10 including the gas flow passage formation plate 22.

In the present embodiment, the projections 26 are arranged at equal intervals on the gas flow passage formation plate 22. Further, the openings 29 all open in the same direction. This allows for the projections 26 including the openings 29 and having the same form to be arranged over the entire gas flow passage formation plate 22. Accordingly, the diffusion of gas in the gas flow passage 27 and the discharge of water to the water flow passage 28 are performed in a well-balanced manner over the entire gas flow passage formation plate 22.

In the present embodiment, the anode side of the gas flow passage formation plate 32 has the same structure as the cathode side of the gas flow passage formation plate 22. Thus, the projections 36 and the openings 39 of the gas flow passage formation plate 32 at the anode side operate in the same manner as the projections 26 and the openings 29 of the gas flow passage formation plate 22 at the cathode side as described above.

The above embodiment has the advantages described below.

(1) The openings 29 and 39 are formed in only one of the opposing walls of the adjacent projections 26 and 36. This allows for quick discharge of water W from the gas flow passages 27 and 37 to the water flow passages 28 and 38. Thus, increases in the pressure loss of the gas flow passages 27 and 37 caused by the remaining water W are limited, and decreases in the power generation efficiency of the fuel cell stack are limited.

(2) Each of the projections 26 includes the opening 29. Further, each of the projections 36 includes the opening 39. This improves the discharge performance of the cell 10 including the gas flow passage formation plates 22 and 32.

(3) The openings 29 and 39 all open in the same direction. Thus, the diffusion of gas in the gas flow passages 27 and 37 and the discharge of water to the water flow passages 28 and 38 are performed in a well-balanced manner over the entire gas flow passage formation plates 22 and 32.

It should be apparent to those skilled in the art that the present invention may be embodied in many other specific forms without departing from the spirit or scope of the invention. Therefore, the present examples and embodiments are to be considered as illustrative and not restrictive, and the invention is not to be limited to the details given herein, but may be modified within the scope and equivalence of the appended claims.

The arrangement of the projections 26 on the gas flow passage formation plate 22 and the arrangement of the projections 36 on the gas flow passage formation plate 32 may be modified.

As long as the openings 29 and 39 are formed in only one of the opposing walls of the two adjacent projections 26 and 36, the direction toward which the openings 29 and 39 open may be changed. With such a gas flow passage formation plate, water between adjacent projections 26 and 36 (in gas flow passages 27 and 37) reaches only one of the openings 29 and 39. This allows for quick discharge of water from the gas flow passages 27 and 37 to the water flow passages 28 and 38. Specific examples of modified gas flow passage formation plates including openings that open in other directions will now be described.

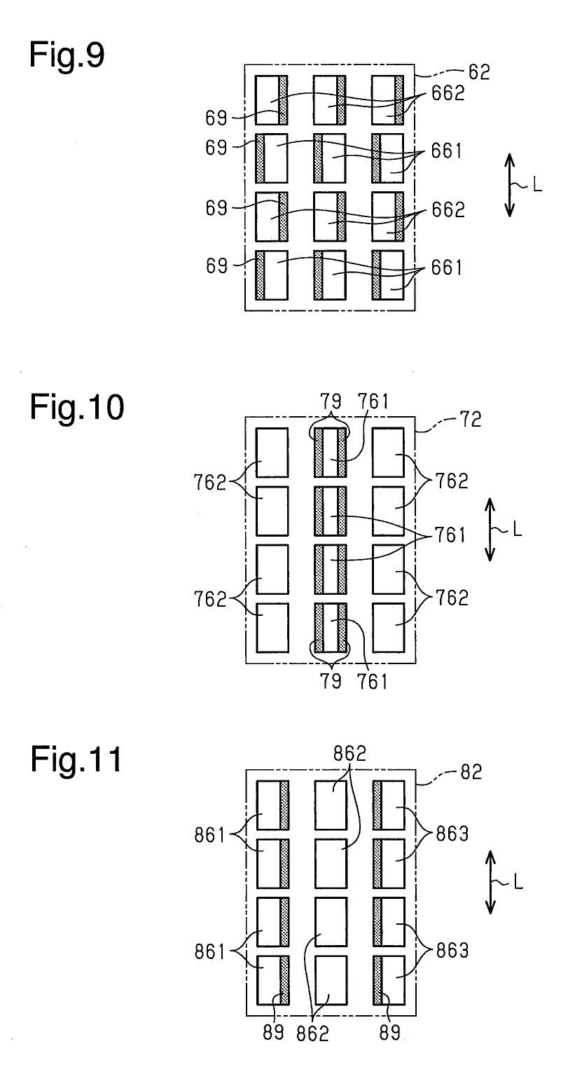

FIG. 9 shows a gas flow passage formation plate 62 that includes projections 661 and projections 662 alternately arranged in a serpentine manner in an extension direction L. The projections 661 and 662 each include an opening 69. Each projection 661 has a side wall located toward one side (left side as viewed in FIG. 9) of the gas flow passage formation plate 62 that includes the opening 69. Each projection 662 has a side wall located toward the other side (right side as viewed on FIG. 9) of the gas flow passage formation plate 62 that includes the opening 69. The projections 661 including the openings 69 in the walls located toward the same side are aligned in the direction orthogonal to the extension direction L (orthogonal direction). In the same manner, the projections 662 including the openings 69 in the walls located toward the same side are aligned in the direction orthogonal to the extension direction L.

FIG. 10 shows a gas flow passage formation plate 72 including projections 761 arranged in the extension direction L and projections 762 arranged in the extension direction L. The projections 761 each include the openings 79 in its two side walls. The projections 762 do not include the opening 79. The rows of the projections 761 and the rows of the projections 762 are alternately arranged in the orthogonal direction. As shown by the example of FIG. 10, all of the projections do not necessarily have to include the opening.

FIG. 11 shows a gas flow passage formation plate 82 including projections 861 with openings 89 in the side walls located toward one side (right side as viewed in FIG. 11) of the gas flow passage formation plate 82. The projections 861 are arranged in the extension direction L and form the leftmost row in the orthogonal direction. A row second from the leftmost row in the orthogonal direction is formed by projections 862 that do not include the openings 89. A row third from the leftmost row in the orthogonal direction includes projections 863 with the openings 89 in the side walls located toward the other side (left side as viewed in FIG. 11) of the gas flow passage formation plate 82.

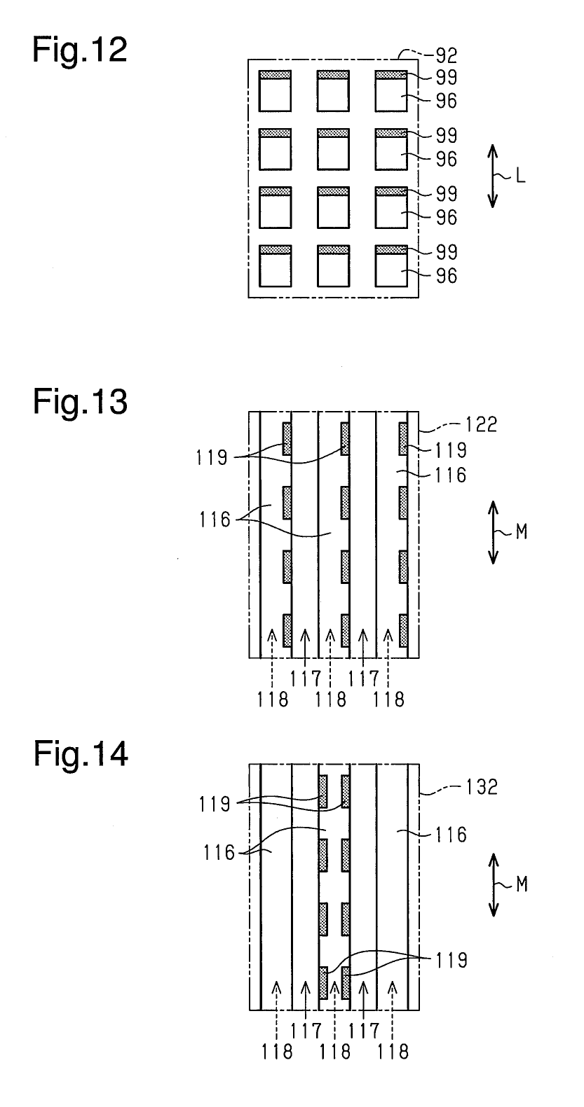

FIG. 12 shows a gas flow passage formation plate 92 including projections 96 with openings 99 in walls located toward one side (upper side as viewed in FIG. 12) in the extension direction L.

The opening may be included in both of the opposing walls of the two adjacent projections. In this case, in a state in which the openings sandwich the portions between adjacent projections (gas flow passage), the two openings are located so as not to oppose and overlap each other in a direction that is orthogonal to the direction in which gas flows in the portions between adjacent projections.

With the above gas flow passage formation plate, the opening is formed in both of the opposing walls of the adjacent projections. However, the openings are not aligned in the orthogonal direction. Accordingly, compared to a gas flow passage formation plate on which the openings are aligned in the orthogonal direction, the water in the gas flow passage is more likely to reach only one opening. Thus, water in the gas flow passage is less likely to be pulled toward the opposite sides by the openings formed in the both opposing walls of adjacent projections. This allows for quick discharge of water from the gas flow passage to the water flow passage.

As schematically shown in FIGS. 13 and 14, the membrane electrode assembly 13 (refer to FIG. 1) and the flat separator 21 or 31 may sandwich a gas flow passage formation plate that include a plurality of protrusions 116 projecting toward the membrane electrode assembly 13 (upward from plane of FIGS. 13 and 14) and arranged at intervals. In the gas flow passage formation plate, the portion of the gas flow passage formation plate at the side opposing the membrane electrode assembly 13 including regions between two adjacent protrusions 116 functions as a gas flow passage 117. Further, the portion of the gas flow passage formation plate at the side opposing the flat separator (downward from plane of FIG. 13) including the inside of the protrusions 116 functions as a water flow passage 118. More specifically, the gas flow passage 117 includes groove-like portions formed between two adjacent protrusions 116. The gas flow passage 117 mainly functions as a passage that circulates gas (fuel gas or oxidant gas). The water flow passage 118 includes groove-like portions formed inside the protrusions 116. The water flow passage 118 mainly functions as a passage that discharges the water produced during power generation in the membrane electrode assembly 13. The gas flow passage formation plate is a curved in a wave-shaped manner in a direction orthogonal (orthogonal direction) to a direction in which the protrusions 116 extend, that is, a direction in which the gas flow passage 117 extends (extension direction M). The gas flow passage formation plate includes a plurality of openings 119 that are formed in a side wall of each protrusion 116. The opening 119 connects the inside of the protrusion 116 (water flow passage 118) and the outside of the protrusion 116 (gas flow passage 117). The plurality of openings 119 are only formed in one of the opposing walls of adjacent protrusions 116.

FIG. 13 shows a gas flow passage formation plate 122 including the protrusions 116 that each include the openings 119 in only one of the side walls (right side wall as viewed in FIG. 13) in the extension direction M.

FIG. 14 shows a gas flow passage formation plate 132 including the protrusions 116 with the openings 119 arranged in both side walls in the extension direction M and the protrusions 116 that do not include the openings 119. The protrusions 116 with the openings 119 and the protrusions 116 without the openings 119 are alternately arranged.

With such gas flow passage formation plates, the water produced during power generation in the membrane electrode assembly 13 flows into the gas flow passage 117 and reaches only one opening 119. This prevents a situation in which the water in the gas flow passage 117 is pulled and drawn into the openings formed in the both opposing walls of adjacent protrusions 116. Thus, compared to the cell of the comparative example that allows the above situation, the water in the gas flow passage 117 is more easily drawn into the water flow passage 118. This allows for quick discharge of water from the gas flow passage 117 to the water flow passage 118.

The opening arranged in the projection (or protrusion) of the gas flow passage formation plate does not necessarily have to be a single through hole. That is, the opening may include a plurality of openings. Specifically, openings that form a meshed structure, openings that form the structure of a perforated metal, or an opening that is divided into a plurality of openings by wall-like (or column-like) components may be used.

The structure of the gas flow passage formation plate in the above embodiment does not necessarily have to be applied over the entire gas flow passage formation plate. That is, the structure of the gas flow passage formation plate in the above embodiment may only be applied to part of the gas flow passage formation plate. Application of the structure of the gas flow passage formation plate in the above embodiment to portions of a cell at which the water discharge performance is likely to be lower (for example, portions located at downstream in gas flow direction) allows for quick discharge of water from the gas flow passage to the water flow passage.

Instead of the flat separators 21 and 31 having the form of a flat plate, any partition plate may be used, such as a partition plate that includes recesses and projections (dimples and bumps) or a wave-shaped partition plate.

1. A gas flow passage formation plate for a fuel cell, wherein the gas flow passage formation plate is located between a membrane electrode assembly and a partition plate and is included in a separator of a cell in a fuel cell, the gas flow passage formation plate comprising:
a plurality of projections that project toward the membrane electrode assembly, wherein the projections are arranged in a first direction and a second direction that is orthogonal to the first direction;
a gas flow passage formed by a portion of the gas flow passage formation plate at a side opposing the membrane electrode assembly and including regions between adjacent ones of the projections;
a water flow passage formed by a portion of the gas flow passage formation plate at a side opposing the partition plate and including an inside of each of the projections; and
a plurality of openings, each formed in a side wall of one of the projections and connecting the inside and an outside of the projection, wherein in a state in which the openings sandwich the regions between adjacent ones of the projections, the openings are arranged so as not to oppose and overlap each other in a direction orthogonal to a direction in which gas flows in the regions between adjacent ones of the projections.

2. The gas flow passage formation plate according to claim 1, wherein the openings are formed in only one of opposing walls of adjacent ones of the projections.

3. The gas flow passage formation plate according to claim 1, wherein each of the openings is a single through hole.

4. The gas flow passage formation plate according to claim 1, wherein each of the openings is formed in each of the projections.

5. The gas flow passage formation plate according to claim 1, wherein the projections are arranged at equal intervals and the openings all open in the same direction.

6. A gas flow passage formation plate for a fuel cell, wherein the gas flow passage formation plate is located between a membrane electrode assembly and a partition plate and is included in a separator of a cell in a fuel cell, the gas flow passage formation plate comprising:
a plurality of protrusions located at intervals and projected toward the membrane electrode assembly;
a gas flow passage formed by a portion of the gas flow passage formation plate at a side opposing the membrane electrode assembly and including regions between adjacent ones of the protrusions;
a water flow passage formed by a portion of the gas flow passage formation plate at a side opposing the partition plate and including an inside of each of the protrusions; and
a plurality of openings, each formed in a side wall of one of the protrusions and connecting the inside and an outside of the protrusion, wherein the openings are formed in only one of opposing walls of adjacent ones of the protrusions.

7. A fuel cell stack, comprising:
a stack of cells, wherein
each of the cells includes a membrane electrode assembly and a pair of separators that sandwich the membrane electrode assembly, and
at least one of the two separators includes a partition plate and the gas flow passage formation plate according to claim 1 that is located between the partition plate and the membrane electrode assembly.

8. A fuel cell stack, comprising:
a stack of cells, wherein
each of the cells includes a membrane electrode assembly and a pair of separators that sandwich the membrane electrode assembly, and
at least one of the two separators includes a partition plate and the gas flow passage formation plate according to claim 6 that is located between the partition plate and the membrane electrode assembly.
